(19) United States
(12) Patent Application Publication
(10) Pub. No.: US 2011/0281716 A1
(43) Pub. Date: Nov. 17, 2011

(54) Wear Tiles for Centrifugal Separators

(76) Inventor: David E. Hurd, Conroe, TX (US)

(21) Appl. No.: 12/780,097

(22) Filed: May 14, 2010

(51) Int. Cl. B04B 1/20; F01D 5/14

(52) U.S. Cl. 494/53; 416/224

(57) ABSTRACT

A wear tile includes a support member and a wear plate formed of material known as Cerbide. A plurality of the tiles may be secured to any structure that is subject to wear, such as the rotating vane section of a centrifugal separator.

### BACKGROUND OF INVENTION

1. Field of the Invention

This invention disclosed in this application is directed to wear tiles that are, as an example, secured to the rotating vanes in a centrifugal type material separator.

2. Description of Related Art

Centrifugal type material separators are used in various environments to separate solids and liquids. Typically a rotating member includes vanes which contact the solids as the solids are separated from the liquid. The vanes wear down by contact with the solids over a period of time. It is known to secure a plurality of wear tiles over the outer portions of the vanes to protect the vanes. However, these tiles also are subject to abrasion and need to be replaced from time to time. This is a costly process and results in serious down time for the separator. Any improvement in the life cycle of these wear tiles would result in significant cost savings.

### BRIEF SUMMARY OF THE INVENTION

The present invention resides in the use of ceramic material comprised of a densified tungsten carbide-containing ceramic as the wear resistant material for wear tiles to be secured to the vanes of centrifugal separators. The wear tiles include a support member and a plate portion which is secured to the support member by any known method such as braizing. The material referred to herein above is known as Cerbide and is described in U.S. Pat. No. 6,843,824 and 7,309,373, the contents of both of which is expressly incorporated by reference herein. BRIEF DESCRIPTION OF THE SEVERAL VIEWS OF THE DRAWING(S)

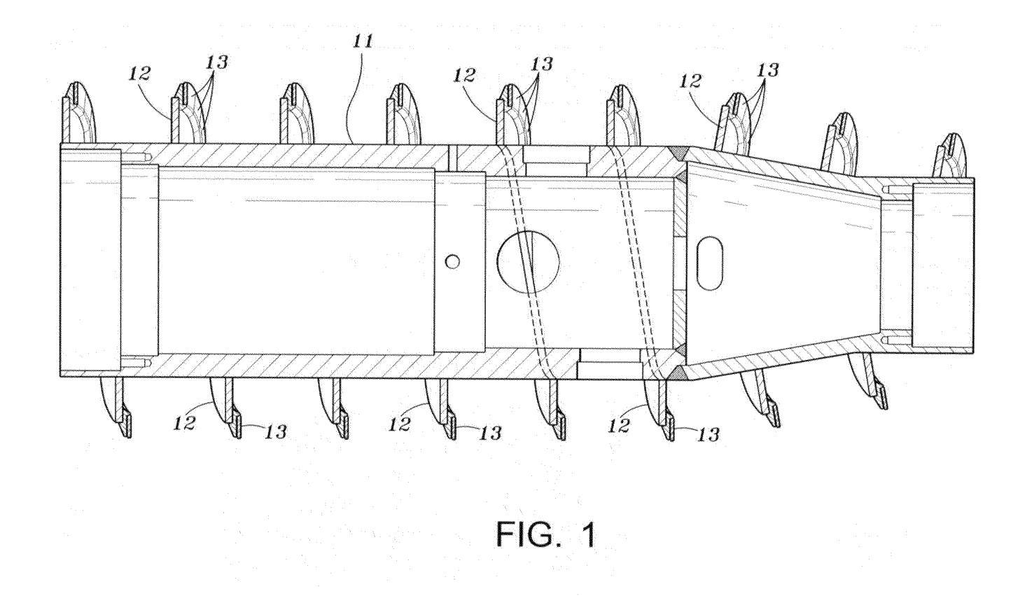

FIG. 1 is a cross sectional view of the rotating'portion of a centrifugal separator.

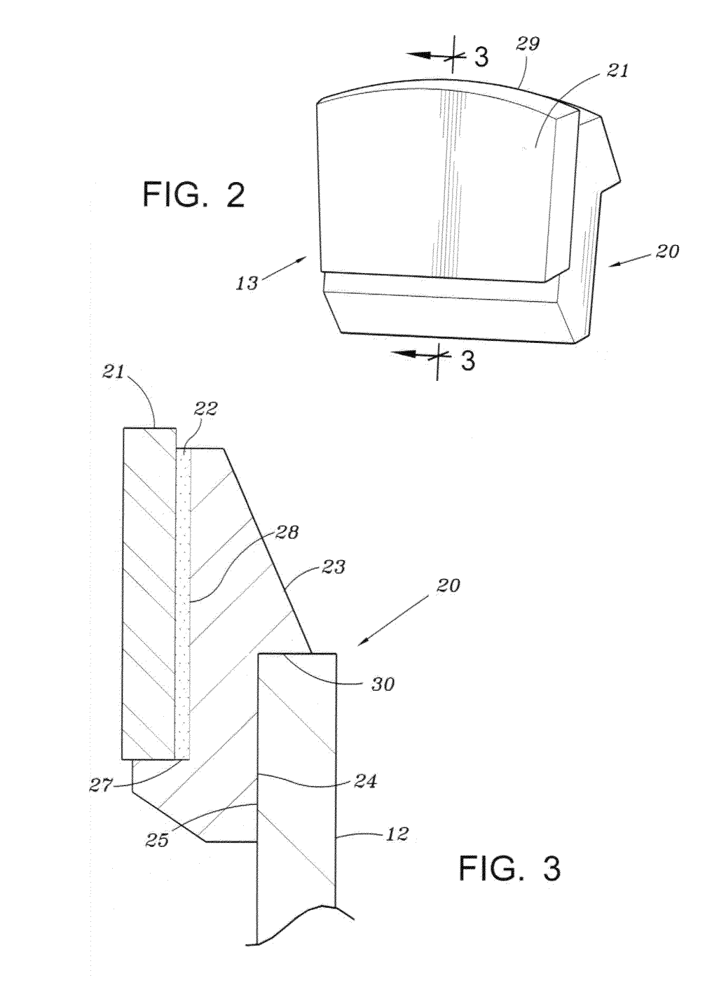

FIG. 2 is a perspective view of a wear tile according to an embodiment of the invention.

FIG. 3 is a cross sectional view taken along line 3-3 of FIG. 2.

### DETAILED DESCRIPTION OF THE INVENTION

FIG. 1 illustrates the rotating body portion 11 of a typical centrifugal separator for which the wear tiles of the present invention is particularly suited. Such a separator is shown for example in U.S. Pat. No. 1,383,313. Body 11 has on its outer periphery a spiral or helix vane 12 extending along its length that comes into, contact with the liquid-solid mixture. The end portion of the vane is subject to abrasion from the material being separated. As shown in FIG. 3, a plurality of wear tiles 13 according to the invention are secured to the end portion of the vane 12 by any suitable means including welding.

FIG. 2 illustrates a perspective view of one of the wear tiles 13. The tile is composed of two portions, the wear plate 21 and a support member 20. Wear plate 21 is a generally flat piece having a generally rectangular shape with a curved upper profile as shown at 29.

Wear plate 21 is secured to support member 20 by any suitable method such as braizing with a suitable braizing material shown at 22 in FIG. 3.

Wear plate 21 has a flat rear surface that is secured to a flat rear surface 28 of support member 20 using braizing material 22. Wear plate 21 is also supported by a step 27 on the rear portion 28 of support member 20.

Support member 20 has a generally planar front surface 25 and a shoulder 30 which are dimensional so as to fit over the tip portion of vane 12 as shown in FIG. 3. Each tile 13 is secured to the top of vane 12 using any known technique, for example, welding.

According to the invention, wear plate 21 is formed of a densified tungsten carbide-containing ceramic known as Cerbide. This material has a hardness greater than that of the tungsten carbide materials now used for the tiles. Cerbide is characterized by having a transverse rupture strength of at least about 300,000 pounds-per-square-inch and a Rockwell A-scale hardness between about 95 and about 96 at 20 degrees Centrigrade. it is manufactured and sold by Cerbide Inc. and is described in U.S. Pat. Nos. 6,845,824 and 7,309,373.

In use a plurality of separate wear tiles are formed by securing the wear plate 21 to support members 20 by any known method such as braizing. The tiles are then secured to the vane 12 of the rotating body portion 11 of the centrifugal separator by any known method such as welding.

Although the present invention has been described with respect to specific details, it is not intended that such details should be regarded as limitations on the scope of the invention, except to the extent that they are included in the accompanying claims.

1. A wear tile for the vane portion of a centrifugal separator comprising:
a support member; and
a wear plate secured to the support member, said wear plate being composed of a material having a transverse rupture strength of at least. about 300,000 pounds-per-square-inch and a Rockwell. A-scale hardness between about 95 and about 96 at 20, degrees Centigrade.

2. The wear tile of claim 1 wherein the material is Cerbide.

3. The wear tile of claim 1 wherein the wear plate is secured to the support member by braizing.

4. A centrifugal separator comprising:
a rotor body having a spiral vane extending along its length; and
a plurality of wear tiles secured to an outer edge of the vane, said wear tiles comprising a support member and a wear plate secured to the support member, said wear plate being composed of a material having a transverse rupture strength .of at least about 300,000 pounds-per-square-inch and a Rockwell A-scale hardness between about 95 and 96 at 20 degrees Centigrade.
